(19) United States
(12) Patent Application Publication
(10) Pub. No.: US 2015/0241124 A1
(43) Pub. Date: Aug. 27, 2015

(54) HIGH TEMPERATURE BAKING FURNACE

(71) Applicants: CERITHERM, Oradour-sur-Vayres (FR); DIREXA ENGINEERING, LLC, Colorado, CO (US); SEIPIA, Palaiseau (FR)

(72) Inventors: Giovanni Zamparo, Oradour-sur-Vayres (FR); Christophe Aubertot, Denver, CO (US); Philippe Hatton, Palaiseau (FR)

(21) Appl. No.: 14/430,380

(22) PCT Filed: Sep. 3, 2013
(86) PCT No.: PCT/FR2013/052018

§ 371 Date: Mar. 23, 2015

(30) Foreign Application Priority Data
Sep. 21, 2012 (FR) 12 58857

(51) Int. Cl. F27B 9/26; F27B 9/24; F27B 9/22

(52) U.S. Cl. CPC F27B 9/26; F27B 9/22; F27B 9/2469

(57) ABSTRACT

A high temperature baking furnace. Inside the cooking tunnel, it includes longitudinal fixed support and guide structures (10), mobile elements (13) that can be moved along the fixed structures (10) and support the loads to be baked (4), and rolling elements (14) between the fixed structures (10) and the mobile elements (13) to allow the movement of the mobile elements along the fixed structures.

The present invention relates to a method and the devices intended to allow the movement of loads inside furnaces, in particular high temperature furnaces intended for the baking of ceramics.

The expression “high temperatures” is used here to denote processing temperatures in the range between 700 and 1800 degrees Celsius.

In general terms, a furnace is constituted by a chamber inside which the conditions of temperature, pressure and atmosphere necessary for the transformation of the products to be baked are achieved.

The expression “baking tunnel” is used here to denote the zone delimited by the four adjacent walls, being: the two lateral walls also referred to as “right feet”, the upper surface referred to as the “roof” and the lower surface referred to as the “bed”.

The scope of the invention is limited to the furnaces in which the products to be baked are introduced into the baking chamber via one of the extremities of the baking tunnel and emerge after heat treatment either via the same extremity, or via the opposite extremity.

Doors or some other means permitting the exchanges between the baking chamber and the atelier to be controlled are sometimes available at the extremities of said tunnel.

The most familiar and also the oldest method of moving the products to be baked inside a furnace has been to position them on mobile structures that are generally referred to as “furnace cars”, the products to be baked being placed on the upper surface of said cars.

The upper zone of each of the furnace cars is constituted by a slab of refractory materials and thermal insulation materials intended, on the one hand, to support the load of the products to be baked and, on the other hand, to limit the thermal exchanges with the outside of the furnace.

Said slab of refractory and insulating materials is supported by a metal chassis, which is itself equipped with wheels or some other mechanical means permitting the furnace car to be moved easily.

The slab of refractory and insulating materials forms a thermal shield between the high temperature baking zone and the mechanical means of transport situated beneath the metal chassis.

In the furnace, the furnace cars are arranged in contact with each other and thereby constitute the bed of the baking tunnel.

In order to insulate the baking tunnel, situated above the bed, from the service passage, situated below the bed, it is well known to provide, on the one hand, sealing aprons carried by the furnace cars at the same height as the bed and, on the other hand, sand trays that are integral with the lateral walls of the furnace. Interacting means of this kind are described in documents DE 23 54 463 and DE 20 16 537.

The metal chassis and said mechanical means of movement must be maintained at an acceptable temperature for the materials and the lubrication products that are used. For this purpose, forced ventilation or natural convection of the zone beneath the cars is generally provided within the design of the furnace.

This solution is used universally today, in spite of the fact that it has numerous disadvantages:
The upper slab of the furnace cars is subjected to thermal deformation stresses.
The refractory and insulating materials of the upper slab represent a mass of several hundred kilograms per useable square meter. They are subject to the thermal and mechanical stresses of the baking cycle in a repetitive manner and give rise to maintenance costs for the operators.
The upper slab and the chassis are responsible for about thirty percent of the thermal consumption of the furnace.
The necessary cooling of the chassis and the mechanical means of movement represents a thermal consumption that has no bearing on the transformation of the products.
The thermal and aeraulic leaks, on the one hand, between the fixed lateral walls of the baking tunnel and the mobile cars and, on the other hand, between the cars themselves, are the reason for a consumption of thermal energy, for heterogeneity inside the baking tunnel and for the degradation by overheating of the mechanical means of movement.
The thermal insulation of the mobile cars is more difficult to obtain than that of the fixed walls of the baking tunnel, which leads to thermal losses and mechanical friction due to the lateral sealing systems.
The metal chassis are subjected to cycles of heating and cooling and sustain permanent deformations in spite of the cooling systems that are provided.
The mass and the thermal inertia of the cars restrict the use of this type of furnace to slow cycles, generally in excess of ten hours.

Certain manufacturers have imagined replacing the furnace cars occupying the entire width of the baking tunnel with narrow cars, thus forming a plurality of parallel mobile structures in the bed of the baking tunnel, yet without solving either the problems of sealing or the overheating of the mechanical means of movement situated under the narrow cars.

Another known solution to the problem of the movement of the products inside the furnaces is the roller furnace.

In a roller furnace, the baking tunnel is delimited by fixed walls constituting the bed of the furnace, the roof and the lateral walls.

In a roller furnace, the products to be baked are placed on rollers passing through the lateral walls of the baking tunnel. Said rollers are supported and driven in rotation by a mechanism situated on the outside of the baking tunnel on the lateral walls.

This solution, which is very widespread in the tile-making industry, is limited by the length of the rollers and the load capable of being supported by said rollers.

A further disadvantage of the roller furnace is the lack of sealing due to the numerous passages of the rollers over the lateral walls of the baking tunnel.

The purpose of the invention is to propose a solution for the movement of the products inside a baking tunnel, of which all the walls are fixed, and without any mechanical element intended for the movement of the products passing through any of the four fixed and adjacent walls which delimit said tunnel.

The invention has as its object a high temperature baking furnace, comprising:
longitudinal fixed support and guide structures, and
mobile elements that can be moved along the fixed structures and support the loads to be baked,

characterized in that it comprises rolling means between the fixed structures and the mobile elements to allow the movement of the mobile elements along the fixed structures; in that the movement of the loads inside the furnace is assured in the absence of interaction between the walls of the baking tunnel and the means of moving the loads in the furnace, and in that, inside the baking tunnel, said fixed structures, said mobile elements and said rolling means are subjected to the same conditions of temperature and atmosphere as the zone of the baking tunnel where they are situated.

Advantageously, the fixed structures pass through the baking tunnel from one end to the other and comprise sections arranged end-to-end, each section being maintained in position by one or a plurality of support members resting on one or a plurality of the fixed walls of the baking tunnel.

In an advantageous manner, the mobile elements are juxtaposed with mutual support and their movement is assured by action on certain of the elements situated close to the extremities of the baking tunnel.

Preferably, the rolling means, known as skids, are constituted by an assembly of from two to six wheels having at least one cylindrical zone, connected together at their axis by one or a plurality of spacers intended to limit the relative movement of the wheels and thereby to prevent two adjacent wheels of the same skid or of two successive skids from coming into contact.

Advantageously, the profile of the wheels is adapted to the profiles of the sections of the fixed structures and of the mobile elements so as to allow the longitudinal guiding of the mobile elements as they move.

In an advantageous manner, the profile of the mobile elements is adapted to the profile of the sections of the fixed structures so as to allow the longitudinal guiding of the mobile elements on the fixed structures.

Preferably, the cylindrical zones of the wheels receiving the load of mobile elements possess a diameter different to those transmitting this load to the sections of the fixed structures.

Advantageously, the skids move at a speed lower than that of the mobile elements.

The invention also has as its object a method of routing the loads to be baked in a high temperature baking furnace, characterized by the steps of:
on longitudinal fixed support and guide structures, positioning at intervals skids capable of allowing movement,
on the skids, positioning mobile elements juxtaposed in the longitudinal direction of movement,
on the mobile elements, placing the baking supports and the loads to be baked,
at the extremities of the tunnel, applying a push to the mobile elements to cause them to advance.

Advantageously, the mobile elements and the skids are picked up at the exit from the tunnel by a handling device which transfers them outside the baking tunnel as far as the entrance in order to be reused.

The invention is described with reference to the accompanying drawings, in which:

FIG. 1 depicts a schematic view in cross section of a baking tunnel equipped with furnace cars according to the prior art.

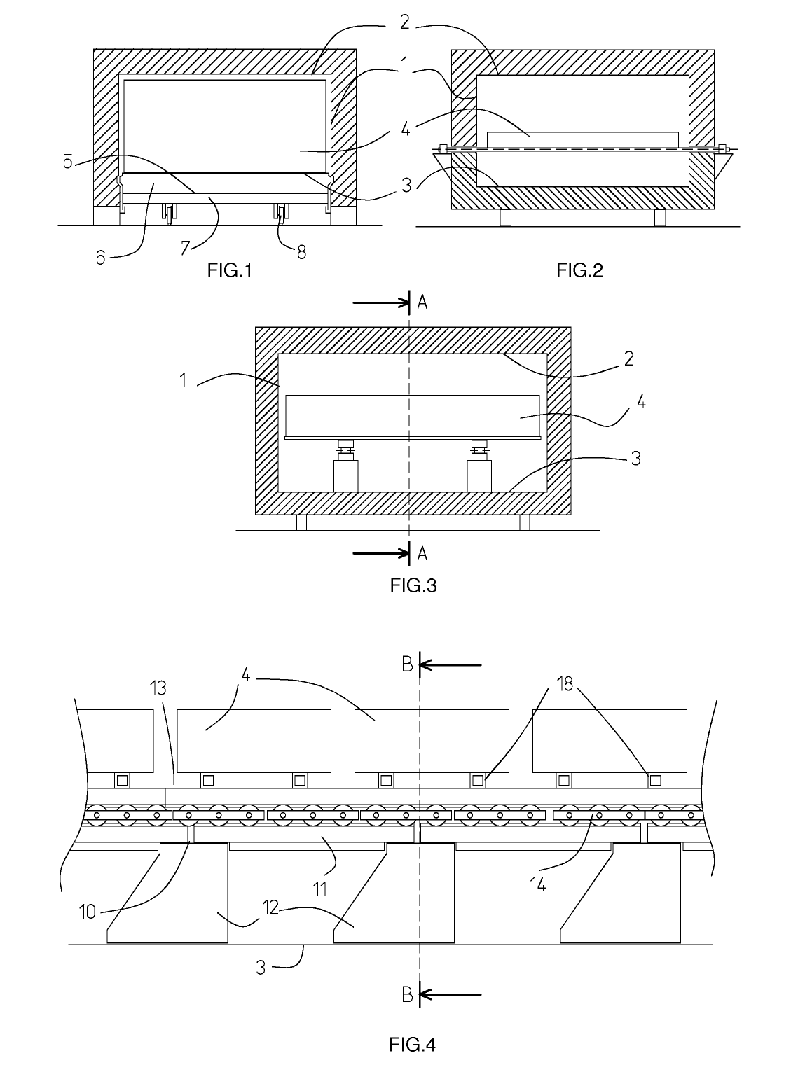

FIG. 2 depicts a schematic view in cross section of a roller hearth furnace according to the prior art.

FIG. 3 depicts a schematic view in cross section of the baking tunnel and the devices according to the invention.

FIG. 4 depicts a side view, according to the section AA, of an embodiment of a device according to the invention in which the support members for the fixed sections are placed on the bed of the baking tunnel.

FIG. 5 depicts a section according to BB of the view in FIG. 4.

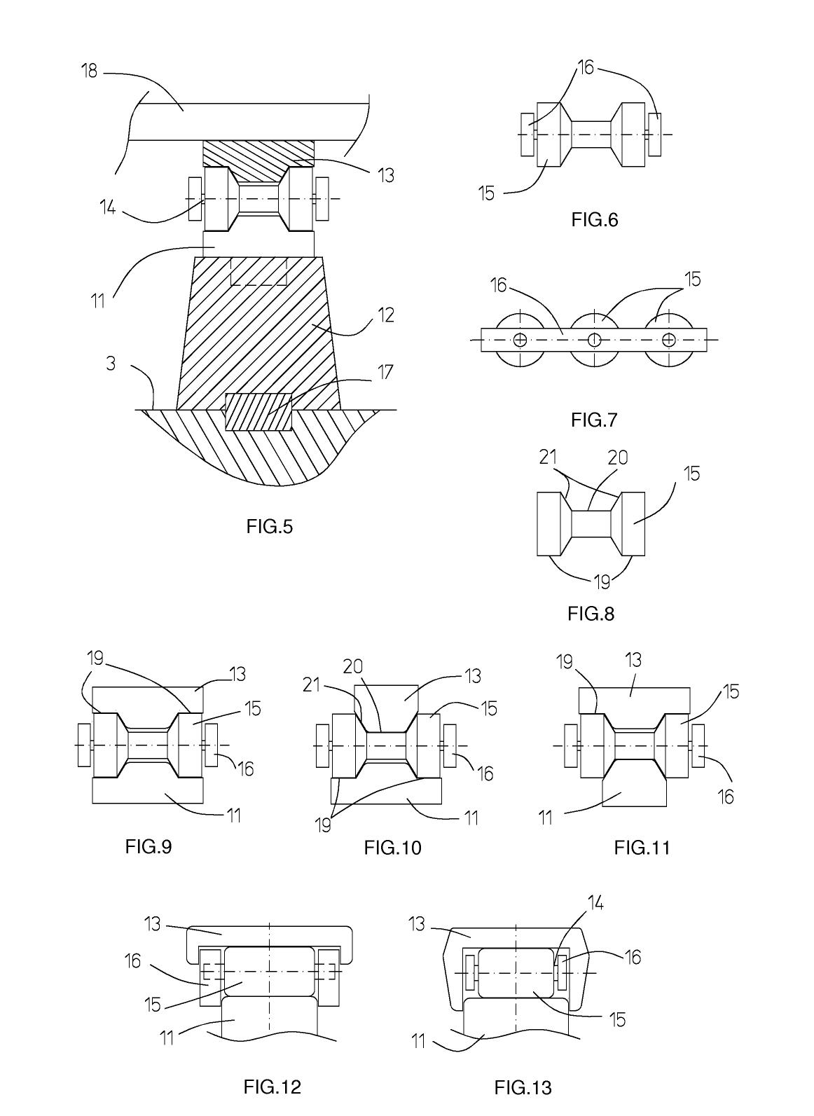

FIG. 6 depicts, as a front view, an embodiment of a skid according to the invention.

FIG. 7 depicts, as a side view, an embodiment of a skid according to the invention.

FIG. 8 depicts an embodiment of a wheel.

FIG. 9 depicts an embodiment of the invention in which the transfers of load between the mobile elements and the fixed sections involve the same cylindrical zones of the wheels.

FIGS. 10 and 11 depict an embodiment of the invention in which the transfers of load between the mobile elements and the fixed sections involve different zones of the wheels.

FIG. 12 depicts an embodiment in which the longitudinal guiding between the fixed sections and the mobile elements takes place by means of the spacers of the skids.

FIG. 13 depicts an embodiment in which the longitudinal guiding of the mobile elements is assured by the fixed structures.

With reference to these drawings, it is possible in the different views to distinguish the lateral walls 1, the roof 2 and the bed 3 of the baking tunnel and the loads of products to be baked 4.

Depicted in FIG. 1 are a furnace car 5, the slab of refractory and insulating materials 6, the metal chassis 7 and the mechanical means of movement 8 according to the prior art of the furnaces with cars.

In FIG. 2, the rollers 9 according to the prior art of the roller hearth furnaces support the load 4.

In FIGS. 3 to 13, it is possible to distinguish the fixed structures 10, the fixed sections 11, the support members 12 being intended to maintain the fixed sections in position in relation to the baking tunnel. It is also possible to distinguish the mobile elements 13, the skids 14, the wheels 15 and the spacers of the wheels 16.

In FIGS. 4 and 5, the support members 12 for the fixed sections 11 are positioned on the bed 3 of the baking tunnel and are maintained in position by a locking means 17 on said bed. The sections 11 of the fixed structures are likewise maintained in position on the support members 12.

It is also possible to distinguish the baking supports that are configured as bars 18 and the loads of products to be baked 4.

In FIGS. 4 and 5, the longitudinal guiding of the mobile elements 13 on the fixed structures is assured by the dolly profile of the wheels 15 and the complementary forms of the fixed sections and of the mobile elements.

FIGS. 6 and 7 show a particular illustrative embodiment of a skid equipped with three wheels 15 that are kept apart by two spacers 16 situated on either side of the wheels.

In FIG. 8, it is possible to distinguish the two external cylindrical zones of the same diameter 19 connected by a cylindrical zone having a smaller diameter 20 and two planes or conical connecting zones 21 that are used for lateral guiding between the fixed sections and the mobile elements. The angle of the connecting zones with the cylindrical zones may vary between 90 and 45 degrees.

In FIG. 9, the transfer of the load between the mobile element 13 and the fixed section 11 takes place by the contact with the external cylindrical zones 19 of the wheel.

In FIG. 10, the mobile element 13 rests on the cylindrical zone of the small central diameter 20 of the wheel, while the fixed section 11 is in contact with the cylindrical zones with a large diameter 19. The lateral guiding is obtained by the contact on the lateral zones 21 of the wheel. This arrangement reduces friction while aligning the wheels naturally.

FIG. 11 shows a reversed arrangement to that in FIG. 10, where the mobile element 13 rests against the cylindrical zones with large diameters 19 of the wheel and the fixed section 11 rests against the central cylindrical zone.

In FIG. 12, the guiding between the fixed section 11 and the mobile element 13 is assured by means of the spacers 16. The wheels 15 may be cylindrical in this case, since they no longer assure the guiding function.

In FIG. 13, the profile of the mobile elements 13 is adapted to the profile of the sections 11 of the fixed structures 10 so as to allow the longitudinal guiding of the mobile elements on the fixed structures. The skid 14 is maintained in the lateral position, in the case of FIG. 12 by the fixed structure, and in the case of FIG. 13 by the mobile elements 13.

The devices for the movement of the products in a high temperature baking tunnel according to the invention are constituted on the one hand:
by longitudinal fixed structures 10 positioned inside the baking tunnel and passing through it from one end to the other while being parallel to one another. Said fixed structures 10 are constituted by sections 11 arranged end-to-end, each fixed section being maintained in position by one or a plurality of support members 12 resting on one or a plurality of the fixed walls of the baking tunnel,
by mobile elements 13 carrying the loads to be baked and moving longitudinally on the fixed structures 10.

Said mobile elements 13 are juxtaposed with mutual support, and their movement is assured by action on certain of the elements 13 situated close to the extremities of the baking tunnel.

The installation according to the invention comprises devices 14 arranged between the fixed structures 10 and the mobile elements 13 and facilitating the movement of said elements, which are designated by the expression “skids”.

Baking supports constituted by bars 18 or by frames receive the products to be baked and connect the upper surfaces of the mobile elements 13 transversely to their axes of movement in the baking tunnel.

The invention is further characterized in that:
The skids 14 are constituted by an assembly of from two to six wheels 15 connected together at their axis by one or a plurality of spacers 16 intended to limit the relative movement of the wheels and thereby to prevent two adjacent wheels 15 of the same skid 14 or of two successive skids from coming into contact.
The skids 14 are driven in translation by the rotation of certain of the wheels 15 in contact with the sections 11 of the fixed structure 10 and the mobile elements 13.
The wheels 15, which are not in contact with the sections 11 of the fixed structure 10 or the mobile elements 13 as a result of geometrical irregularities, are driven temporarily by the spacers 16 connecting them to the adjacent wheels.
The skids 14 move at a speed lower than that of the mobile elements 13.
All the mobile elements 13 carrying the loads as they move inside the baking tunnel and the skids 14 are subjected in their entirety to the same conditions of temperature, pressure and atmosphere as the products to be baked.
All the sections 11 of the fixed structures 10 and their supports are situated inside the baking tunnel and are subjected to the same conditions of temperature, pressure and atmosphere as the zone of the baking tunnel where they are fixed.
No device intended to move the loads to be baked passes through the fixed walls of the baking tunnel. Said walls are thus able to receive the thermal and aeraulic equipment necessary for the baking process including, for example, burners, air circulating fans and fluid distribution ducts.
The low mass of the mobile elements 13 which support the products to be baked and permit their movement inside the baking tunnel makes it possible to envisage rapid speeds of movement and thus very short baking cycles without the risk of thermal shock on said elements and without thermal losses.

According to one embodiment, the profile of all or certain wheels 15 is adapted to the profiles of the sections 11 of the fixed structure 10 and of the mobile elements 13 so as to allow the longitudinal guiding of the mobile elements as they move.

According to one embodiment, the cylindrical zones of the wheels 15 receiving the load of mobile elements 13 possess a different diameter to those transmitting this load to the sections 11 of the fixed structure.

According to another embodiment, the longitudinal guiding of the mobile elements 13 on the sections 11 of the fixed structure is assured by the spacers 16 of the skids 14.

According to another embodiment, the profile of the mobile elements 13 is adapted to the profile of the fixed structures 10 so as to allow the longitudinal guiding of the mobile elements 13 on the sections 11 of the fixed structure.

The method of routing the loads to be baked in a furnace according to the invention comprises the steps of:

a) on a longitudinal fixed support and guide structure 10, positioning at intervals skids 14 capable of allowing movement,

b) on the skids 14, positioning mobile elements 13 juxtaposed in the longitudinal direction of movement,

c) on the mobile elements 13, placing the baking supports 18 and the loads 4 to be baked,

d) at one extremity of the tunnel, applying a push to the mobile elements 13 to cause them to advance.

Preferably, the mobile elements 13 and the skids 14 are picked up at the exit from the tunnel by a handling device which transfers them outside the baking tunnel as far as the entrance in order to be reused.

The industrial applications for the invention relate primarily to the tunnel furnaces and batch furnaces of the ceramic and metallurgical industries and more generally to high temperature heat treatment furnaces, controlled atmosphere furnaces or rapid cycle furnaces.

The mode of movement proposed by the invention makes it possible to avoid any thermal losses due to the presence of the mobile load supports such as the furnace cars and to ensure perfect sealing of the baking chamber.

The utilization of the invention permits a reduction in the baking cycles and in the thermal consumption in these industries and the improvement of the quality of the products through the homogeneity of the baking conditions in the section of the baking tunnel.

1. A high temperature baking furnace comprising:
longitudinal fixed support and guide structures (10), and
mobile elements (13) that can be moved along the fixed structures (10) and support the loads to be baked (4), characterized in that it comprises rolling means (14) between the fixed structures (10) and the mobile elements (13) to allow the movement of the mobile elements along the fixed structures; in that the movement of the loads inside the furnace is assured in the absence of interaction between the walls of the baking tunnel and the means of moving the loads in the furnace, and
in that, inside the baking tunnel, said fixed structures (10), said mobile elements (13) and said rolling means (14) are subjected to the same conditions of temperature and atmosphere as the zone of the baking tunnel where they are situated.

2. The high temperature baking furnace as claimed in claim 1, characterized in that the fixed structures (10) pass through the baking tunnel from one end to the other and comprise sections (11) arranged end-to-end, each section (11) being maintained in position by one or a plurality of support members (12) resting on one or a plurality of the fixed walls of the baking tunnel.

3. The high temperature baking furnace as claimed in claim 1, characterized in that the mobile elements (13) are juxtaposed with mutual support and their movement is assured by action on certain of the elements (13) situated close to the extremities of the baking tunnel.

4. The high temperature baking furnace as claimed in claim 1, characterized in that the rolling means known as skids (14) are constituted by an assembly of from two to six wheels (15) having at least one cylindrical zone, connected together at their axis by one or a plurality of spacers (16) intended to limit the relative movement of the wheels (15) and thereby to prevent two adjacent wheels of the same skid or of two successive skids from coming into contact.

5. The high temperature baking furnace as claimed in claim 1, characterized in that the profile of the wheels (15) is adapted to the profiles of the sections (11) of the fixed structures (10) and of the mobile elements (13) so as to allow the longitudinal guiding of the mobile elements (13) as they move.

6. The high temperature baking furnace as claimed in claim 1, characterized in that the profile of the mobile elements (13) is adapted to the profile of the sections of the fixed structures so as to allow the longitudinal guiding of the mobile elements (13) on the fixed structures.

7. The high temperature baking furnace as claimed in claim 1, characterized in that the cylindrical zones of the wheels (15) receiving the load of mobile elements (13) possess a diameter different to those transmitting this load to the sections (11) of the fixed structures (10).

8. The high temperature baking furnace as claimed in claim 7, characterized in that the skids (14) move at a speed lower than that of the mobile elements (13).

9. A method of routing the loads to be baked in a high temperature baking furnace, characterized by the steps of:
on longitudinal fixed support and guide structures, positioning at intervals skids capable of allowing movement,
on the skids, positioning mobile elements juxtaposed in the longitudinal direction of movement,
on the mobile elements, placing the baking supports and the loads to be baked,
at the extremities of the tunnel, applying a push to the mobile elements to cause them to advance.

10. The method as claimed in claim 9, characterized in that the mobile elements and the skids are picked up at the exit from the tunnel by a handling device which transfers them outside the baking tunnel as far as the entrance in order to be reused.

11. The high temperature baking furnace as claimed in claim 2, characterized in that the profile of the wheels (15) is adapted to the profiles of the sections (11) of the fixed structures (10) and of the mobile elements (13) so as to allow the longitudinal guiding of the mobile elements (13) as they move.

12. The high temperature baking furnace as claimed in claim 2, characterized in that the profile of the mobile elements (13) is adapted to the profile of the sections of the fixed structures so as to allow the longitudinal guiding of the mobile elements (13) on the fixed structures.

13. The high temperature baking furnace as claimed in claim 2, characterized in that the cylindrical zones of the wheels (15) receiving the load of mobile elements (13) possess a diameter different to those transmitting this load to the sections (11) of the fixed structures (10).

14. The high temperature baking furnace as claimed in claim 3, characterized in that the profile of the wheels (15) is adapted to the profiles of the sections (11) of the fixed structures (10) and of the mobile elements (13) so as to allow the longitudinal guiding of the mobile elements (13) as they move.

15. The high temperature baking furnace as claimed in claim 3, characterized in that the profile of the mobile elements (13) is adapted to the profile of the sections of the fixed structures so as to allow the longitudinal guiding of the mobile elements (13) on the fixed structures.

16. The high temperature baking furnace as claimed in claim 3, characterized in that the cylindrical zones of the wheels (15) receiving the load of mobile elements (13) possess a diameter different to those transmitting this load to the sections (11) of the fixed structures (10).

17. The high temperature baking furnace as claimed in claim 4, characterized in that the profile of the wheels (15) is adapted to the profiles of the sections (11) of the fixed structures (10) and of the mobile elements (13) so as to allow the longitudinal guiding of the mobile elements (13) as they move.

18. The high temperature baking furnace as claimed in claim 4, characterized in that the profile of the mobile elements (13) is adapted to the profile of the sections of the fixed structures so as to allow the longitudinal guiding of the mobile elements (13) on the fixed structures.

19. The high temperature baking furnace as claimed in claim 4, characterized in that the cylindrical zones of the wheels (15) receiving the load of mobile elements (13) possess a diameter different to those transmitting this load to the sections (11) of the fixed structures (10).

20. The high temperature baking furnace as claimed in claim 5, characterized in that the cylindrical zones of the wheels (15) receiving the load of mobile elements (13) possess a diameter different to those transmitting this load to the sections (11) of the fixed structures (10).
